(19) United States
(12) Patent Application Publication
(10) Pub. No.: US 2023/0174229 A1
(43) Pub. Date: Jun. 8, 2023

(54) TILTROTOR AIRCRAFT WITH CENTERLINE AND WING MOUNTED ENGINES

(71) Applicant: Karem Aircraft, Inc., Lake Forest, CA (US)

(72) Inventors: Abraham Karem, Santa Ana, CA (US); John Paul Parcell, Irvine, CA (US)

(21) Appl. No.: 17/541,905

(22) Filed: Dec. 3, 2021

(51) Int. Cl. B64C 29/00; B64D 27/24

(52) U.S. Cl. CPC B64C 29/0033; B64D 27/24

(57) ABSTRACT

A tiltrotor aircraft comprising a wing carrying an engine on each wing half, and a fuselage-mounted third engine with a transmission system configured to drive each of the tilting rotors from the third engine. The engines may be any powerplant, including fore example, a reciprocating engine, a turbine engine, or an electric motor. The third engine is preferably controlled for best efficiency and best safety in engine failure cases.

### FIELD OF THE INVENTION

The field of the invention is a tiltrotor aircraft.

### BACKGROUND

The background description includes information that may be useful in understanding the present invention. It is not an admission that any of the information provided herein is prior art or relevant to the presently claimed invention, or that any publication specifically or implicitly referenced is prior art.

All current operational or flight-tested tiltrotor aircraft (Bell XV-15 (FIG. 1), Bell Boeing V-22, Agusta Westland AW609 and Bell V-280) are powered by two engines (ranging from 1,550 HP to 6,150 HP each) which are installed in wing-tip nacelles and drive the two rotors through in-nacelle drive trains. Additionally, prior art NASA tiltrotor aircraft designs such as the Large Civil Tiltrotor positioned the engines on the wings close to the rotors' nacelles. The advantages of using either two big engines or four smaller engines prevailed in these designs.

Large tiltrotor aircraft such as the 250,000 pounds Karem Aircraft TR75 (FIG. 2) proposed for the Joint Heavy Lift program adopted the same nacelle and rotor propulsion configuration of the referenced tiltrotors but needed higher power achieved by four 16,000 HP engines, two of which were installed in each nacelle. This growth to four engines is logical for multiple reasons:
Engines larger than 16,000 HP would be impractical to perform maintenance tasks on including extraction and installation;
Four engines have higher percentage of available power in case of One Engine Inoperative (OEI);
Insensitivity of Specific Fuel Consumption (SFC) to engine size above 10,000 HP, as described in the following paragraph.

FIG. 3 shows the SFC vs, maximum power of turboshaft engines using the current advanced technology. Small engines have higher SFC because of the lower thermodynamic efficiency caused by the lower cycle pressure ratio resulting from fewer compressor stages (size limit of the highest-pressure blades) and because of low Reynolds numbers and high blade tip losses, making the designer of tiltrotor aircraft motivated to minimize the number of engines to minimize the engine fuel consumption. SFC of advanced turboshaft engines improves less with engine sizes higher than 10,000 HP making the use of four engines more attractive for large tiltrotor aircraft like the TR75 while preferring the two-engine configuration for smaller aircraft.

Engine size and configuration choices for a tiltrotor aircraft are also influenced by the engine operation. Engines are certificated with specific time allowances at different power output, called ratings. Common ratings are:
Maximum Continuous Rating (MCP)—defined for the desired time between overhaul (TBO) and lower cost per flight hour;
Intermediate Rated Power (IRP)—for defined short time of operation to provide higher climb power while adding cost per flight hour;
Maximum Rated Power (MRP)—for defined short time of operation to provide higher takeoff weight while adding cost per flight hour;
Higher emergency rating for short time of operation One Engine Inoperative (OEI) during takeoff and landing, requiring special maintenance and possible engine removal, overhaul, and part replacement.

Maximum power required by a helicopter or tiltrotor aircraft occurs in hover flight, typically near the ground where there is the lowest margin for recovery from any air disturbance or aircraft component failure affecting the aircraft altitude-holding or rate of climb. To maximize safety, an aircraft would be designed with entirely redundant engines where engine failure has no impact on flight safety. While most military tiltrotor aircraft, by allowing aircraft takeoff weights close to those requiring full MRP, accept the increased risk of insufficient OEI power to continue flight, multi-engine commercial manned aircraft must avoid it. Additionally, to minimize engine maintenance cost per flight hour, an aircraft would be designed to use no more than MCP for all flight conditions. The 30-second limited OEI rated power is typically no higher than 35% greater than MRP, resulting in the original flight trajectory being unsustainable following a single engine failure in a twin-engine tiltrotor aircraft at takeoff weight with close to MRP power. Special takeoff and landing profiles are prescribed for large commercial helicopters (no existing large commercial tiltrotor aircraft) to accommodate this shortcoming.

Moreover, very low (and continuously improving) turbine engine inflight failure rates in scheduled commercial flight result in one OEI event in 300,000-600,000 flight hours. This further motivates the conventional tiltrotor practice of installing two engines per aircraft.

After considering the size and number of engines in an aircraft, they must be positioned on the aircraft. Conventional multi-engine tiltrotor aircraft have engines positioned at the wingtips near the rotors. This layout has several benefits: lower empty weight. lower cabin noise, higher wing bending relief load and easier maintenance access. Engines may be fixed to the tilting rotor system or alternatively fixed to the static wing structure. Examples of these layout selections are the V-22 Osprey and the Bell V-280 Valor. Rotors are typically coupled with a torque transmitting cross-wing shaft and gearbox system. This system is designed to transmit approximately half of the OEI power of the operating engine to the other rotor in the case of single engine failure.

Past single-engine tiltrotor aircraft naturally placed the engine at or near the aircraft centerline in the fuselage. The experimental Bell™ XV-3, which predated widely available turboshaft engines, was constructed with a single fuselage-mounted 450 hp radial piston engine. Its configuration sacrificed fuselage utility, which is not necessary on an experimental flight demo vehicle, to minimize the engine count. A more recent example of a tiltrotor with a fuselage mounted engine can be found in the proposed unmanned Bell™ V-247 Vigilant, envisioned as operating from amphibious assault ships. U.S. Pat. No. 10,279,901 (Ivans) describes the drivetrain configuration of the V-247. Without engines in the nacelles, the folded footprint is minimized, this being a critical feature of a ship-based naval aircraft.

The U.S. Pat. No. 10,279,901 patents as well as all other extrinsic materials discussed herein are incorporated by reference to the same extent as if each such materials were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Turbofan powered fixed-wing transport aircraft are powered by two, three or four engines. The fact that turbofan engines provide their thrust by integrated engine and thruster in a compact assembly allow the engines to be mounted around the fuselage tail cone such as twin-engines in the Bombardier CRJ-500, three-engines in the Boeing 727, and four-engines in the Vickers VC-10. Such engine placement is not desired for tiltrotors which need the engines to power the outboard located rotors.

The engine position justifications mentioned herein apply only to aircraft in which the engines power rotors on the wings. Turbojet and turbofan aircraft exist with a combination of fuselage and wing-mounted engines, such as the Lockheed™ L-1011 and Douglas™ DC-10. Conventional helicopters also include multiple engines mounted to the fuselage, such as the Sikorsky™ CH-53E and Boeing™ CH-47. These applications and the associated design considerations are dissimilar to the tiltrotor application of the inventive subject matter.

### SUMMARY OF THE INVENTION

The inventive subject matter provides apparatus, systems, and methods in which an aircraft with tilting rotors is configured with a combination of wing-mounted engines and a fuselage-mounted engine.

### BRIEF DESCRIPTION OF THE DRAWING

FIG. 1 is a perspective view of the XV-15 prior art tiltrotor.

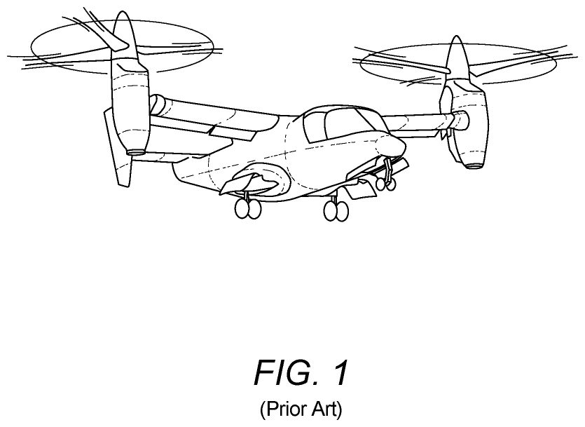

FIG. 2 is a perspective view of the Karem Aircraft TR75 prior art tiltrotor.

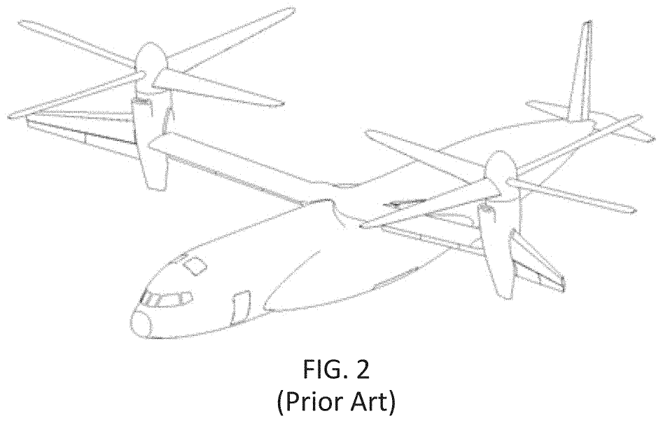

FIG. 3 is a graph of engine specific fuel consumption relative to engine size.

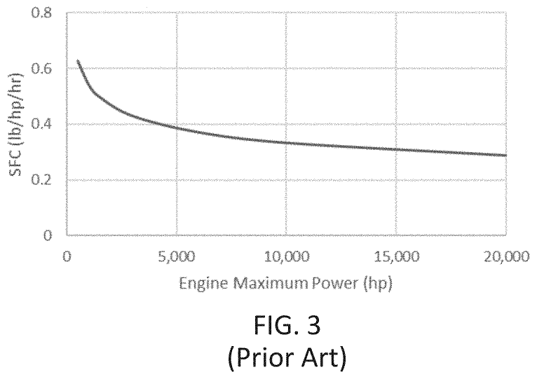

FIG. 4 is a perspective view of the preferred aircraft in wingborne flight configuration.

FIG. 5 is a perspective view of the preferred aircraft from FIG. 4 showing propulsion components.

FIG. 6 is a schematic of the engines, propulsion drive system, and rotors of FIG. 5.

FIG. 7A is a top view of the fuselage-mounted propulsion components.

FIG. 7B is a side view section of the fuselage-mounted propulsion components.

FIG. 8 is a perspective view of an alternative, laterally displaced fuselage-mounted engine position.

FIG. 9 is a schematic view of an alternative embodiment of the systems in FIG. 6 including a battery powered electric fuselage-mounted engine.

FIG. 10 is a schematic of the systems in FIG. 6 with the associated engine computers and control system.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The inventive subject matter incorporates a fuselage-mounted engine in a tiltrotor with wing-mounted engines. Engines can be any powerplant such as reciprocating engine, turbine engine, or electric motor. It provides additional safety through redundancy and additional capability through higher total power beyond what can be achieved by a conventional tiltrotor with exclusively wing-mounted engines. These benefits come without the full operating cost impact of simply including additional engines.

Envisioned operation of the inventive configuration includes helicopter-mode flight with the fuselage-mounted engine at low power to minimize engine noise in the cabin. In the case of a wing-mounted engine failure, the fuselage-mounted engine power increases to compensate. This allows continued safe flight at the critical takeoff, initial climb, and landing conditions. Additional power output from the fuselage-mounted engine also expands the power-limited hover and low-speed flight envelope.

Alternatively, another operating mode consists of the fuselage-mounted engine sharing power equally with the other engines. This produces more noise in the cabin when all engines are in use, which may be undesirable for passenger transportation but would be acceptable for cargo transportation. All engines could operate at or below MCP rating during takeoff and landing, maximizing the TB 0 of all engines and minimizing the time for power to increase to the required level during an engine failure event.

During cruise flight in airplane-mode, the fuselage-mounted engine power can be reduced, or the engine can be shut down to minimize cabin noise and vibration, especially when transporting passengers. Limiting the operation of the fuselage-mounted engine to takeoff and landing segments will reduce the maintenance required compared to the other engines. This limits the additional cost per flight hour impact of the fuselage-mounted engine. The preferred embodiment includes a variable position exhaust flap which minimizes the drag of the fuselage-mounted engine in cruise when the engine is at low power or shut down.

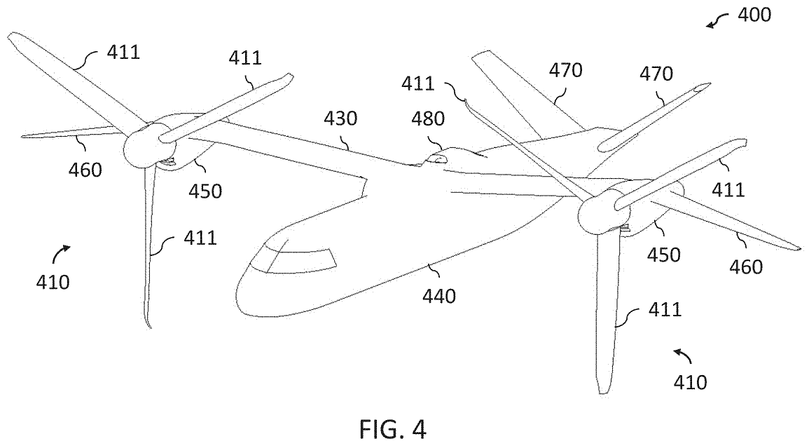

FIG. 4 is an oblique view of the preferred aircraft, 400, in wingborne mode of operation, comprising an inboard wing 430, a fuselage 440, a first and second first nacelle 450, and first and second first rotors 410 comprising multiple blades 411. A first and second first outboard wing 460 extend outboard of the nacelles 450. A first and second first tail 470 are disposed in a V-shape and are coupled to the fuselage 440. Engine fairing 480 guides airflow into and around the fuselage-mounted engine. The aircraft 400 is substantially symmetrical about the longitudinal centerline (not shown) which generally bisects the aircraft into left and right portions, such that, other than possibly being mirror images, the first and second rotors 410 and their respective blades are substantially identical.

In alternative embodiments, the aircraft 400 may not include outboard wings 460. In alternative embodiments, the aircraft 400 may not include tails 470, or the tails 470 may be of other configurations such as T-shape or H-shape.

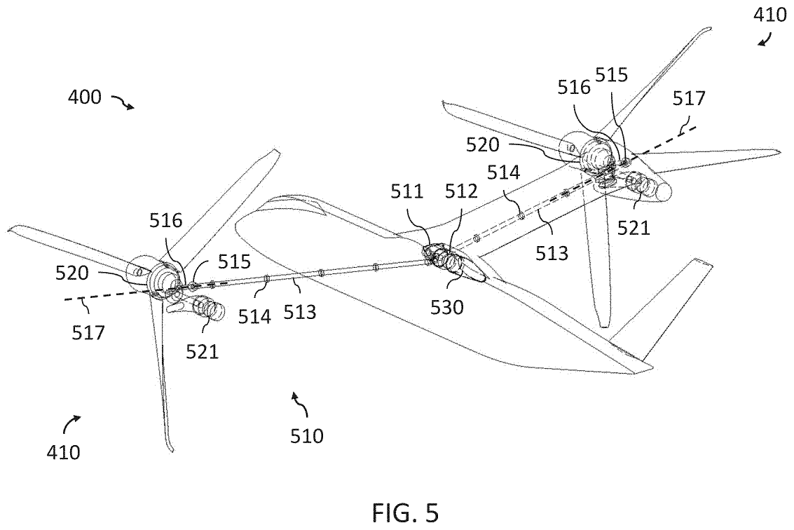

FIG. 5 is an oblique view of the preferred aircraft, 400, in wingborne mode of operation. Portions of the assembly have been removed for ease of viewing. The propulsion drive system 510 comprises a midwing gearbox 511 transmitting power from the fuselage-mounted engine 512 to a first cross-wing driveshaft 513. The cross-wing driveshaft 513 may be divided into multiple axially coupled shafts with one or more intermediate couplings 514 (four per side shown). Inside the nacelle 450 a first tilt-axis gearbox 515 transmits power from the cross-wing driveshaft 513 to the oblique shaft 516. The tilt-axis gearbox 515 allows articulation of the nacelle and rotor system around the tilt axis 517. The main rotor gearbox 520 transmits power between the wing-mounted engine 521, rotor 410, and oblique shaft 516. A variable position exhaust flap 530 is opened when the fuselage-mounted engine is operated and closed to reduce drag at other times.

As in FIG. 4, components shown in FIG. 5 are substantially symmetrical about the longitudinal centerline (not shown) which generally bisects the aircraft into left and right portions, such that, other than possibly being mirror images, propulsion drive system components are substantially identical.

Fuselage mounted engine 512 may be of higher or lower maximum output than the other engines. The propulsion drive system 510 power and torque capacities are sufficient to accept the highest output of any engine.

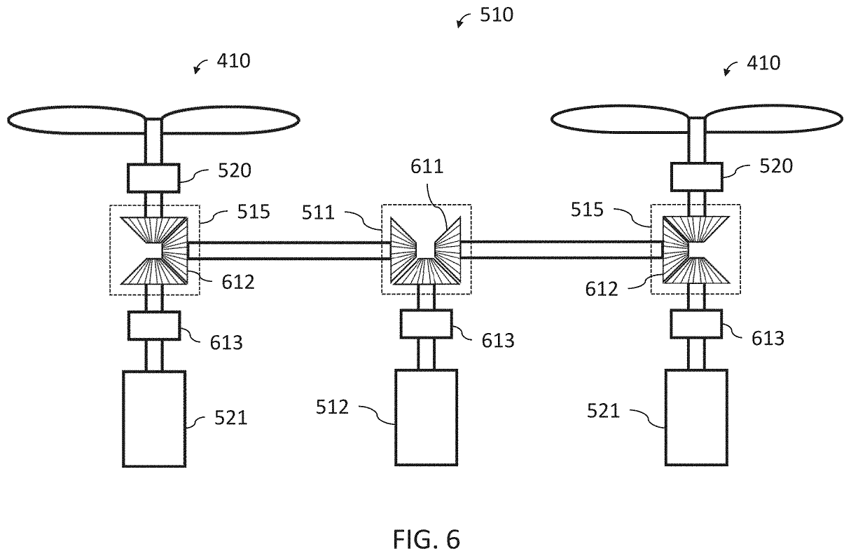

FIG. 6 is a generalized top view schematic of the propulsion drive system 510. The centerline bevel gearset 611 is contained in the midwing gearbox 511. First and second first outboard bevel gearset 612 are representative of angle-changing gearsets contained in the tilt-axis gearboxes 515. The orientations and sizes of each bevel gearset may be adjusted to produce desired engine and rotor rotation directions and speeds. In the preferred embodiment of the propulsion drive system 510, each engine 512 and 521 is coupled to an over-running clutch 613 to allow the propulsion drive system to overrun any of the engine inputs. Consequently, the propulsion drive system continues to deliver torque from operating engines when one or more engines have failed or have been commanded to stop. Additional reduction gearsets may be included to modify the rotor rotational direction and speed. Additional gearsets may be introduced for ancillary drives such as oil pumps.

As in FIG. 4, components shown in FIG. 6 are substantially symmetrical about the longitudinal centerline (not shown) which generally bisects the aircraft into left and right portions, such that, other than possibly being mirror images, propulsion drive system components are substantially identical.

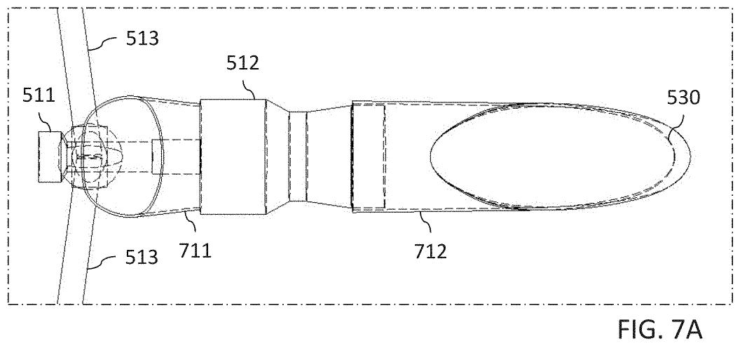

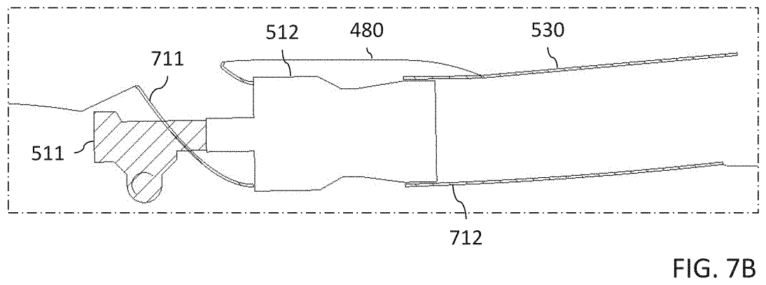

FIGS. 7A and 7B show top and side section views, respectively, of the fuselage-mounted engine 512 and the associated systems. All elements numbered are as previously described. A bifurcated engine inlet 711 guides the engine airflow into the engine. In the preferred embodiment, the engine inlet design is biased toward efficient hover performance rather than efficiency at high airspeeds. Its opening is tilted upwards to minimize spillage drag at high speeds. The fuselage-mounted engine exhaust duct 712 varies in cross sectional area depending on the position of the exhaust flap 530. Opening the exhaust flap 530 for rotorborne flight maximizes exhaust pressure recovery which improves engine power and efficiency. Closing the exhaust flap 530 for high speed flight minimizes base drag of the engine fairing and eliminates additional drag from flow through the engine, thereby improving aircraft performance.

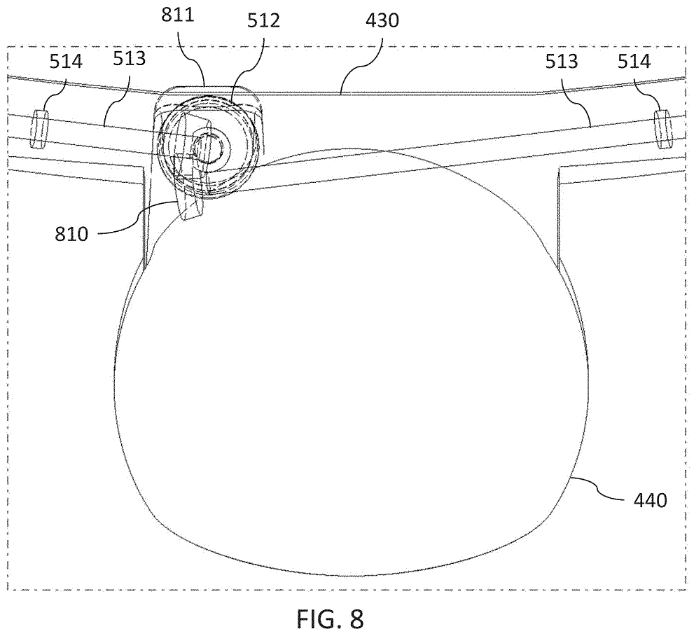

FIG. 8 is a front-view cross section of an alternative embodiment of aircraft 400 with the fuselage-mounted engine 512 displaced from the aircraft centerline. Asymmetric midwing gearbox 810 replaces 511 in the drivetrain. Midwing gearbox 810 contains a bevel gearset which accommodates the sweep and dihedral angle differences between the cross-wing drive shafts 513. This configuration minimizes the incursion of the midwing gearbox and engine into the fuselage 440. Drag is reduced by the smaller protrusion of the fairing 811 for this configuration, thereby improving aircraft performance.

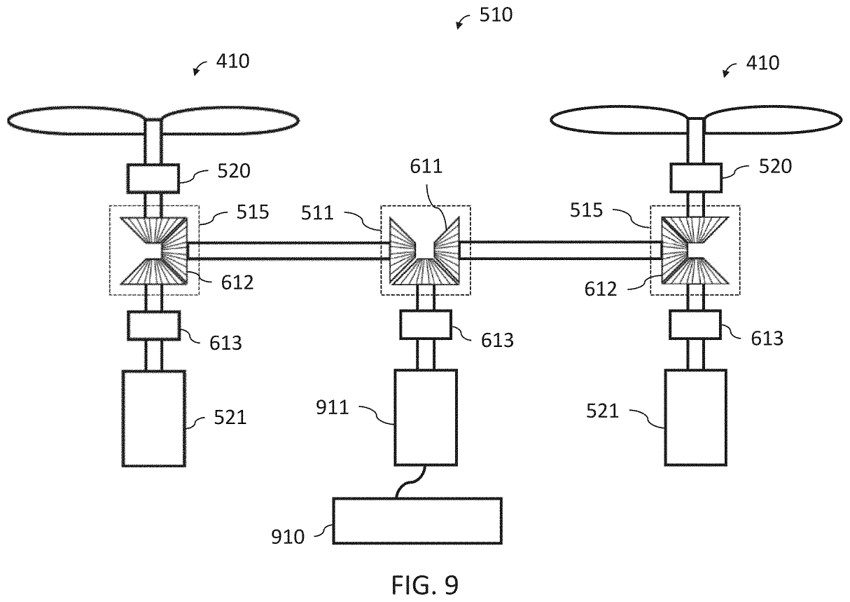

FIG. 9 depicts an alternative embodiment of the propulsion drive system 510 from FIG. 6 configured with an electric powered fuselage-mounted engine 911. A battery pack 910 supplies power to the electric engine 911. The battery pack 910 may be disposed anywhere on the aircraft. An electric fuselage-mounted engine reduces noise and safety issues associated with a gas turbine engine, especially in passenger transport applications. The elimination of engine ducting benefits aircraft performance by reducing the drag and installation impact of the fuselage-mounted engine.

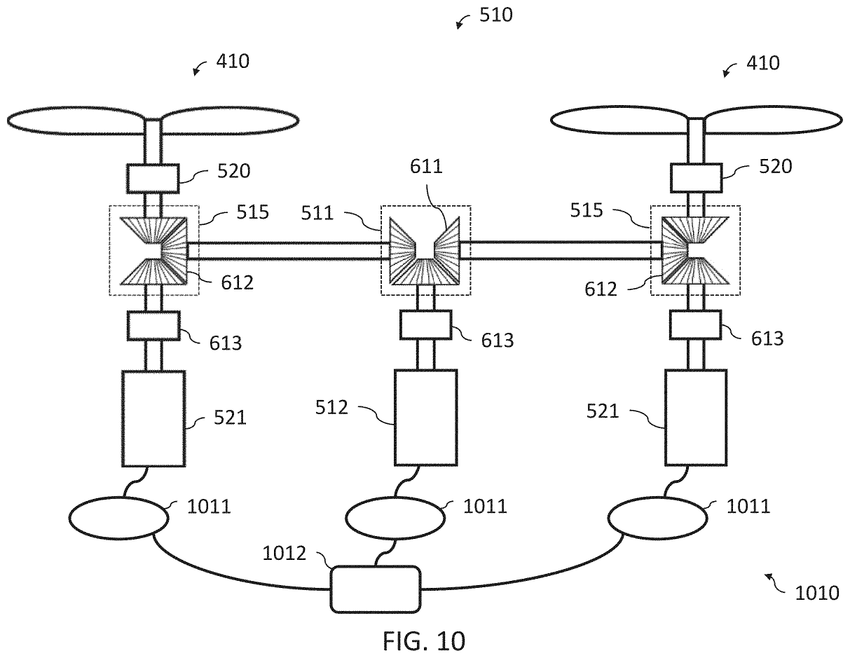

FIG. 10 depicts an alternative embodiment of the propulsion drive system 510 from FIG. 6 with a preferred control system 1010 consisting of a main computer 1012 and engine computers 1011. The main control computer 1012 distributes commands to each engine computer 1011 and can thereby operate the engines concurrently with synchronized power and speed outputs. By having a dedicated engine computer for each engine, the fuselage-mounted engine can alternatively be commanded to stop or start independent of the other engines. The control system 1010 can optimally manage the power and speed of each engine, which is beneficial when the engines are of different types, for example gas turbine and electric powered.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention. Unless a contrary meaning is explicitly stated, all ranges are inclusive of their endpoints, and open-ended ranges are to be interpreted as bounded on the open end by commercially feasible embodiments.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A VTOL aircraft comprising:
a left wing carrying a first engine and a first tilting rotor;
a right wing carrying a second engine and a second tilting rotor;
a fuselage and a fuselage-mounted third engine;
a first driveshaft extending along a portion of the left wing to the fuselage, configured to provide motive power from the third engine to the first tilting rotor; and
a second driveshaft extending along a portion of the right wing to the fuselage, configured to provide motive power from the third engine to the second tilting.

2. The VTOL of claim 1, wherein each of the first and second engines are electrically powered.

3. The VTOL of claim 1, wherein the first and second engines are contained within first and second nacelles, respectively.

4. The VTOL of claim 1, wherein the third engine is electrically powered.

5. The VTOL of claim 1, wherein at least portions of each of the first and second wings are configured to tilt from a first position in vertical flight and hover, and a second position in horizontal flight.

6. The VTOL of claim 1, wherein the third engine is mounted centerline of the fuselage.

7. A The VTOL of claim 1, wherein the third engine is configured to provide maximum power at least equal to maximum power of the first engine, and at least equal to maximum power of the second engine.

8. A The VTOL of claim 1, wherein the third engine is configured to provide maximum power less than maximum power of the first engine, and less than maximum power of the second engine.

9. A The VTOL of claim 1, wherein the third engine is configured to share power equally with the first and second engines.

10. The VTOL of claim 1, further comprising a control system configured to operate the third engine independently of operation of the first and second engines.

11. The VTOL of claim 1, further comprising a control system configured to operate the third engine concurrently with operation of the first and second engines.

12. A method of controlling a VTOL aircraft, comprising a fuselage, a first tilting rotor powered by a first engine mounted on a left wing, and a second tilting rotor powered by a second engine mounted on a right wing, the method comprising providing substitute or supplemental power to the first rotor by a third, fuselage-mounted engine, via a left wing driveshaft extending along a portion of the left wing to the fuselage.

13. The method of claim 12, further comprising providing the substitute or supplemental power upon failure of the first engine.

14. The method of claim 12, further comprising reducing maintenance required for the first and second engines by limiting operation of the third engine to takeoff and landing segments.

15. The method of claim 12, further comprising commanding the third engine to start or stop independently of the first and second engines.

16. The method of claim 12, further comprising providing the substitute or supplemental power to increase power to the first and second rotors during vertical flight.

17. The method of claim 12, comprising a variable position exhaust flap configured to minimizes drag of the third, fuselage-mounted engine when the third, fuselage-mounted engine is at low power or shut down.

18. The VTOL aircraft of claim 1, wherein the third engine is at least partially positioned between the left and right wings.

19. The method of claim 12, wherein the third engine is at least partially positioned between the left and right wings.
